(19) United States
(12) Patent Application Publication
(10) Pub. No.: US 2002/0141692 A1
(43) Pub. Date: Oct. 3, 2002

(54) Optical network with dynamic balancing

(76) Inventor: Henry Hung, Paradise Valley, AZ (US)

Correspondence Address: DONALD J. LENKSZUS, P.C., P.O. Box 3064, Carefree, AZ, 85377-3064, US

(21) Appl. No.: 09/823,476

(22) Filed: Mar. 31, 2001

Related U.S. Application Data
(60) Provisional application No. 60/240,623, filed on Oct. 16, 2000.

(51) Int. Cl. G02B 6/28

(52) U.S. Cl. 385/24; 359/118

(57) ABSTRACT

An optical fiber network comprises a plurality of communications nodes. Each node is able to communicate utilizing multiplexed optical signals comprising a plurality of optical wavelength components. A plurality of optical fiber links interconnects the nodes. A dynamic balancer is inserted into each corresponding optical fiber links. Each dynamic balancer adjusts the intensities of a plurality of optical wavelength components in multiplexed optical signals transmitted over the optical fiber link.

### FIELD OF THE INVENTION

This invention pertains to communications systems utilizing optical fiber, in general, and to apparatus and methods for the dynamic balancing of multiple optical wavelengths in such systems, in particular.

### BACKGROUND OF THE INVENTION

Optical fiber communications networks to date have been configured as point-to-point networks with single point-to-point routing between geographic locations. As the optical fiber network evolves, it is highly likely that point-to-point networks will become more of a mesh type configuration with multiple paths possible between end points. In such mesh networks, multiple optical communications paths interconnect each network node. In a wavelength-multiplexed infrastructure, that utilizes a mesh type network, the paths that the different optical wavelengths traverse may vary by significant amounts. The length of a path has an effect on the power level or intensity of optical signals. The effect of such different path lengths is a lack of uniformity in the power or intensity of multiplexed wavelengths at various nodes in the network.

It is desirable that the multiplexed wavelengths at each node in the network be at the same level or intensity. The present invention provides a method and arrangement for the dynamic balancing or equalization of power for each optical wavelength in a wavelength multiplexed system.

### SUMMARY OF THE INVENTION

In accordance with the invention, an optical fiber network comprises a plurality of communications nodes. Each node is able to communicate utilizing multiplexed optical signals comprising a plurality of optical wavelength components. A plurality of optical fiber links interconnects the nodes. A dynamic balancer is inserted into each corresponding optical fiber links. Each dynamic balancer adjusts the intensities of a plurality of optical wavelength components in multiplexed optical signals transmitted over the optical fiber link.

In accordance with one aspect of the invention each dynamic balancer adjusts the intensities to be substantially the same level. Each dynamic balancer comprises a control loop for each optical wavelength component. The control loop is used to adjust the intensities.

In accordance with another aspect of the invention, each dynamic balancer comprises a single micro controller utilized for all control loops.

In accordance with another aspect of the invention, each dynamic balancer comprises a plurality of variable optical attenuators, each of which is operable to adjust the intensity of one corresponding optical wavelength component.

### BRIEF DESCRIPTION OF THE DRAWING

The invention will be better understood from a reading of the following detailed description in conjunction with the drawing figures in which like reference indicators are used to identify like elements, and in which:

FIG. 1 is a network diagram of a mesh network to which the invention is advantageously applied:

FIG. 2 is a wavelength intensity diagram;

FIG. 3 is a second wavelength intensity diagram;

FIG. 4 is a wavelength intensity diagram illustrating the intensity of wavelengths at a network node in accordance with the principles of the invention:

FIG. 5 is dynamic equalizer in accordance with the principles of the invention;

FIG. 6 is a diagram of a variable optical reflector/attenuator in accordance with the principles of the invention;

FIG. 7 is a diagram of a second variable optical reflector isolator in accordance with the principles of the invention;

FIG. 8 is a cross-section of a non-reciprocal phase shifter in accordance with the invention; and

FIG. 9 is a cross-section of a second non-reciprocal phase shifter in accordance with the principles of the invention.

### DETAILED DESCRIPTION

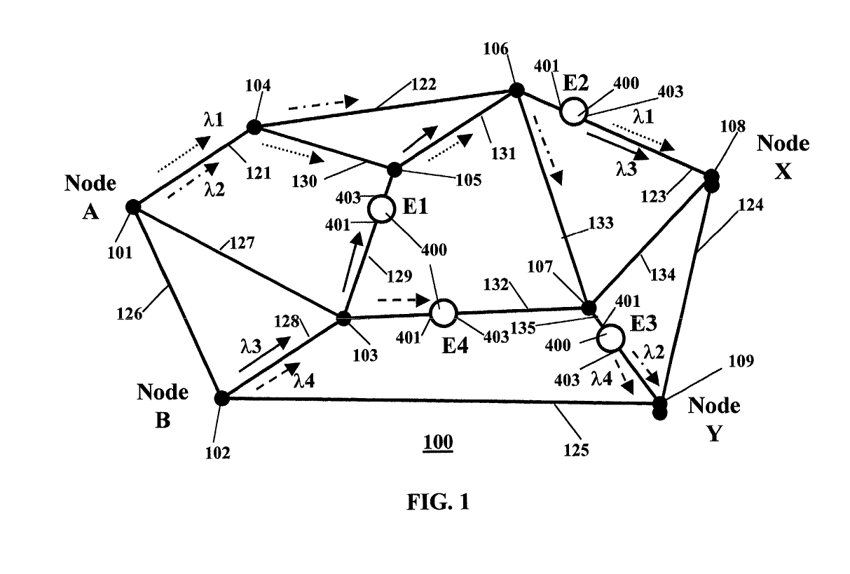

FIG. 1 illustrates a mesh network 100 illustrative of the present invention. Mesh network 100 includes a plurality of communications nodes 101,102 . . . 109. Each node 101,102 . . . 109 is typically at a different geographic location, however, as those skilled in the art will appreciate, nodes may be collocated in the same geographic location and at the same or different physical locations. However, in the illustrative embodiment of the invention, mesh network 100 represents a portion of a national network for the United States. Considering a typical situation, each node might represent a different switching or routing office or a different city. Node 101 may, for example, be located in San Francisco, Calif.; node 102 may be located in Phoenix, Ariz.; node 108 may be located in New York, N.Y.; and node 109 may be located in Atlanta, Ga. In the optical communications system utilizing the mesh network 100, communications occurs over multiple optical wavelengths that are multiplexed. Fiber optic links 121, 122, 123, . . . , 135 link the various nodes 101,102 . . . 109 to form mesh network 100. Each link may include multiple optical fibers.

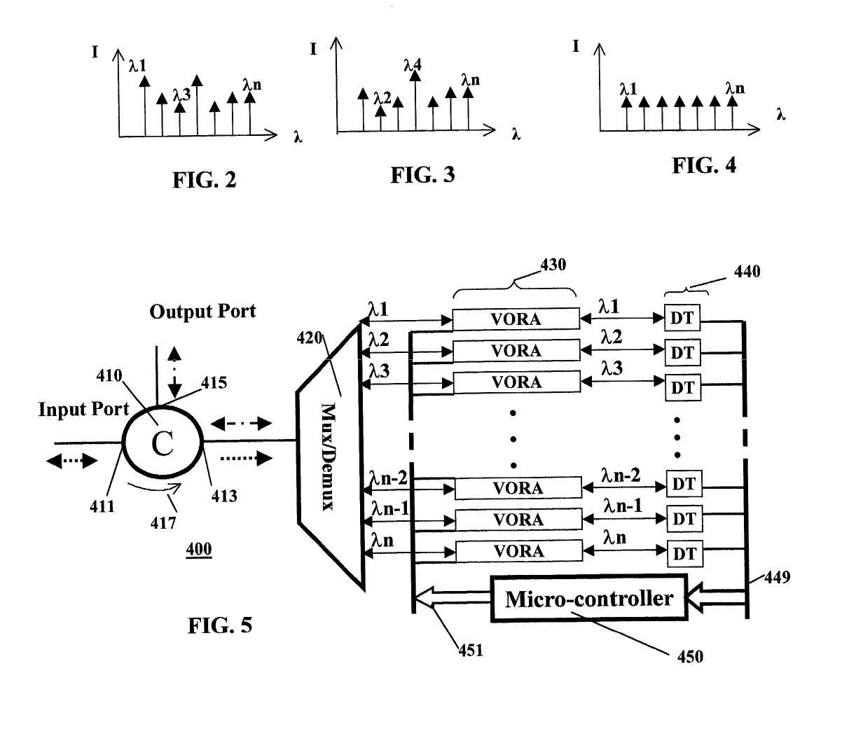

Multiplexing of optical wavelengths is known and various arrangements are available in the prior art to provide multiplexed optical wavelength communications. In the example shown in FIG. 1, only four multiplexed wavelengths λ1, λ2, λ3, λ4 are shown for purposes of clarity. Each wavelength is represented by arrows to indicate the routing of that wavelength component in mesh network 100. However, the invention is applicable to network arrangements in which any numbers of optical wavelengths are multiplexed together. The particular problem to which the present invention provides a solution is illustrated in FIG. 1. Two wavelength components λ1, λ2 carry information from node 101. Wavelength λ1 carries information for node 108, and wavelength λ2 carries information for node 109. Similarly, two wavelengths λ3, λ4 carry information from node 102. Wavelength λ3 carries information for node 108, and wavelength λ4 carries information for node 109. Thus wavelengths λ1, λ3 carry information for node 108 and wavelengths λ2, λ4 carry information for node 109. Wavelength λ1 travels a network route from node 101 to node 104 via link 121, from node 104 to node 105 via link 130, from node 105 to node 106 via link 131, and from node 106 to node 108 via node 123. Wavelength λ3 travels a network route from node 102 to node 103 via link 118, from node 103 to node 105 via link 129, from node 105 to node 106 via link 131, from link 106 to node 108 via link 123. Wavelength λ2 travels a network route from node 101 to node 104 via link 121, from node 104 to node 106 via link 106, from node 106 to node 107 via link 133, and from node 107 to node 109 via link 135. Wavelength λ4 travels a network route from node 102 to node 103 via link 118, from node 103 to node 107 via link 132, and from node 107 to node 109 via link 135. Because the network path lengths over the links from node 101 to node 108 and over the links from node 102 to node 108 are different, the power levels or intensities of wavelength component λ1 and wavelength component λ3 at node 108 will be different. This is shown in graphical form in FIG. 2, which illustrates the intensity of wavelengths received at node 108. Similarly, the power or intensity levels between wavelength λ2 and wavelength λ4 received at node 109 are different because of the differences in path lengths for the different wavelength components as illustrated in FIG. 3. It is undesirable to have wavelength components of different intensities. In accordance with the principles of the invention, the intensity of all wavelength components received at a node are adjusted to be at the same intensity level as illustrated in FIG. 4.

Turning back to FIG. 1, in accordance with one aspect of the present invention, an optical communications network that utilizes multiplexing of wavelength component signals and provides a plurality of paths interconnecting a plurality of nodes includes dynamic equalizers disposed in the different network path segments to provide for dynamic balancing of wavelength components. In FIG. 1 four dynamic equalizers 400 are shown. It will be understood by those skilled in the art that every network path segment or link may include one or more dynamic equalizers 400 to provide for appropriate balancing of wavelength component intensity. For clarity, dynamic equalizers 400 are also identified as dynamic equalizers E1, E2, E3, E4. Dynamic equalizers 400 each provide an adjustment to the wavelength component signals to equalize the path lengths in the network for all communications paths. Thus, equalizer E1 operates on wavelength λ3 from nodes 102, 103. Equalizer E2 operates on wavelengths λ1, λ3. Equalizer E3 operates on wavelengths λ2, λ4. Equalizer E4 operates on wavelengths λ4 from nodes 102, 103. Each dynamic equalizer E1, E2, E3, E4 is identical and includes two ports 401, 403 that are coupled into the network links or paths. The wavelength intensity plot shown in FIG.2 represents the input to equalizer E2. The wavelength intensity plot shown in FIG. 3 represents the input to equalizer E3. The output wavelength intensity plot for both equalizers E2, E3 is shown in FIG. 4. As can be seen from FIG. 4, equalizers E2, E3 operate on the input wavelength signal components to balance or equalize all the wavelength components to the same level of intensity.

Turning now to FIG. 5, a dynamic balancing equalizer 400 is shown. Dynamic balancing equalizer 400 has ports 401, 403 and includes a circulator 410, a multiplexer/de-multiplexer 420, a plurality of variable optical reflector/attenuators 430, a plurality of detectors 440 and a micro-controller 450. Circulator 410 has ports 411, 413, 415. Arrow 417 indicates the circulation direction. Port 401 receives unbalanced input wavelength component signals from the mesh network. Port 413 is coupled to multiplexer/de-multiplexer 420 and port 403 is coupled into mesh network 100 and provides balanced wavelength signal components back into mesh network 100. Multiplexer/de-multiplexer 420 are a bi-directional unit that can couple or de-multiplex each one of n wavelength components to a corresponding one of a plurality of variable optical reflector/ attenuator units 430. In addition, reflected signals from each of the corresponding variable optical reflector/attenuator units 430 are coupled or multiplexed by multiplexer/de-multiplexer 420 back to port 413 of circulator 410. Circulator 410 couples the wavelength component signals from multiplexer/de-multiplexer 420 to port 403.

Each variable optical reflector/attenuator units 430 is coupled to a corresponding one detector 440. Each detector 440 is utilized to provide a signal representative of the intensity of the particular wavelength component that its corresponding variable optical reflector/attenuator 430 receives. Each detector 440 couples signals representative of the detected wavelength intensity to a micro-controller 450. Micro-controller 450 utilizes the signals to determine the amount of adjustment to each variable optical reflector/attenuator 430 necessary to cause all wavelength component outputs at output port 415 to be the same. Detectors 440 are part of an intensity control loop that includes micro-controller 450 to determine the intensities of output wavelength components. The structure shown and described in FIG. 5 is unidirectional in that wavelength components flow only in a direction of from port 401 to port 403.

In another embodiment of the invention, circulator 410 is replaced by the equivalent of a bidirectional circulator that allows wavelength component signals at port 401 to circulate to port 413 and reflected signals to circulate from port 413 to port 403 and further allows wavelength signal components receive at port 403 to circulate to port 413, and reflected signals to circulate form port 413 to port 401. As will be appreciated by those skilled in the art, such a bi-directional circulator may be implemented easily with a pair of conventional unidirectional circulators and isolators. Such a device is referred to herein as a bi-directional circulator.

Detectors 440 may be detectors of a type known in the art. Micro-controller 450 may be a micro-controller of a type known in the art. Micro-controller 450 utilizes signals from each detector 440 to generate control signals at output 451 to control the intensity of each corresponding wavelength component to a desired predetermined level. Micro-controller 450 may utilize any of the known methods of correlating input signals to adjustment signals for each wavelength. The known methods include, but are not limited to table look up methods and algorithm based methods. In any event, micro-controller 450 is part of n control loops for each of the corresponding n wavelengths to adjust the intensity of each on a dynamic basis to produce the desired predetermined output level.

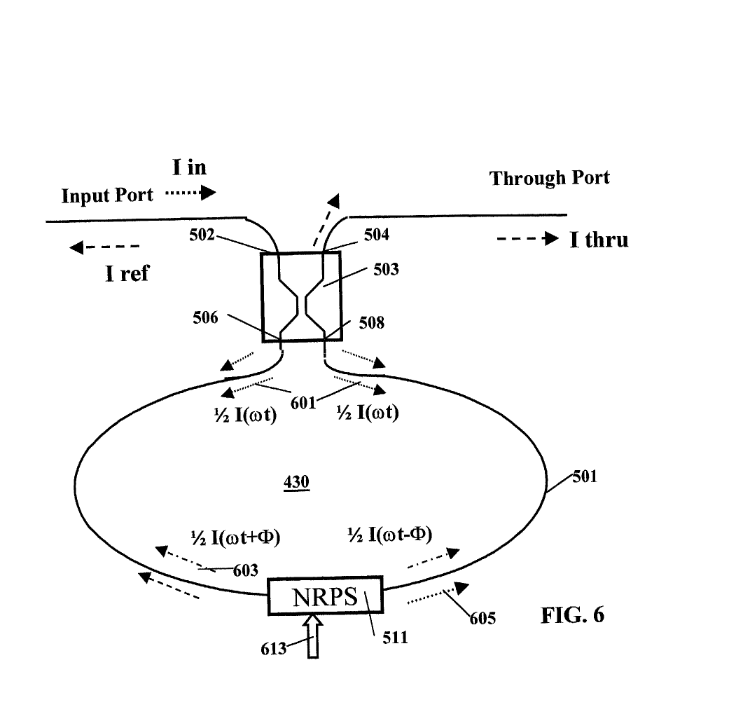

Variable optical attenuator/reflector 430 of the invention is configured similarly to a Sagnac Interferometer. As shown in FIG. 6, variable optical attenuator/reflector 430 includes a non-reciprocal phase shifter 511 disposed in an optical fiber loop 501. A coupler 503 having ports 502, 504, 506, 508 is utilized. Coupler 503 is a 50/50 coupler. Input wavelength component signals received at port 502 are attenuated by a desired amount and reflected back out to port 502. Portions of the wavelength components are outputted at port 504. When utilized as a variable attenuator/reflector, port 504 may not be used. Non-reciprocal phase shifter 511 creates a +Φ phase shift for light propagating in a clockwise direction in loop 501 and a −Φ phase shift for counter-clockwise propagating light. The reflection rate depends on the power ratio between Ithru and Iin, which in turn depends on the Φ phase shift produced by NRPS 51. For a phase shift of Φ=0°, Ithru=0% and Iref=100%. For a phase shift of Φ=45°, Ithru =50% and Iref=50%. For a phase shift of Φ=90°, Ithru=100% and Iref=0%. Varying the control signal at input 613 varies the phase shift angle Φ and accordingly varies the amount of light reflected back to the input port. Non-reciprocal phase shifter 511 thus controls the intensity of the output at through port 502.

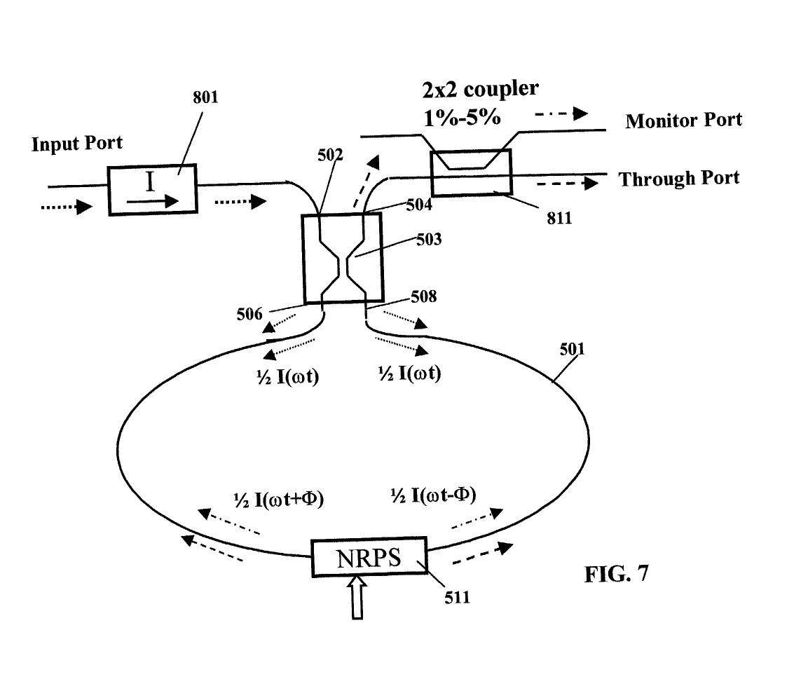

FIG. 7 illustrates a modification to the arrangement of FIG. 6 to provide monitoring capability for the coupling of optical signals to detectors. In the arrangement of FIG. 7, a second coupler 811 is utilized to provide a tap for monitor signals. Coupler 811, extracts a small amount of light, typically 1% to 5%. The extracted light is coupled to a corresponding detector 440. In all other respects, operation of the arrangement of FIG. 7 is like that of the arrangement of FIG. 6.

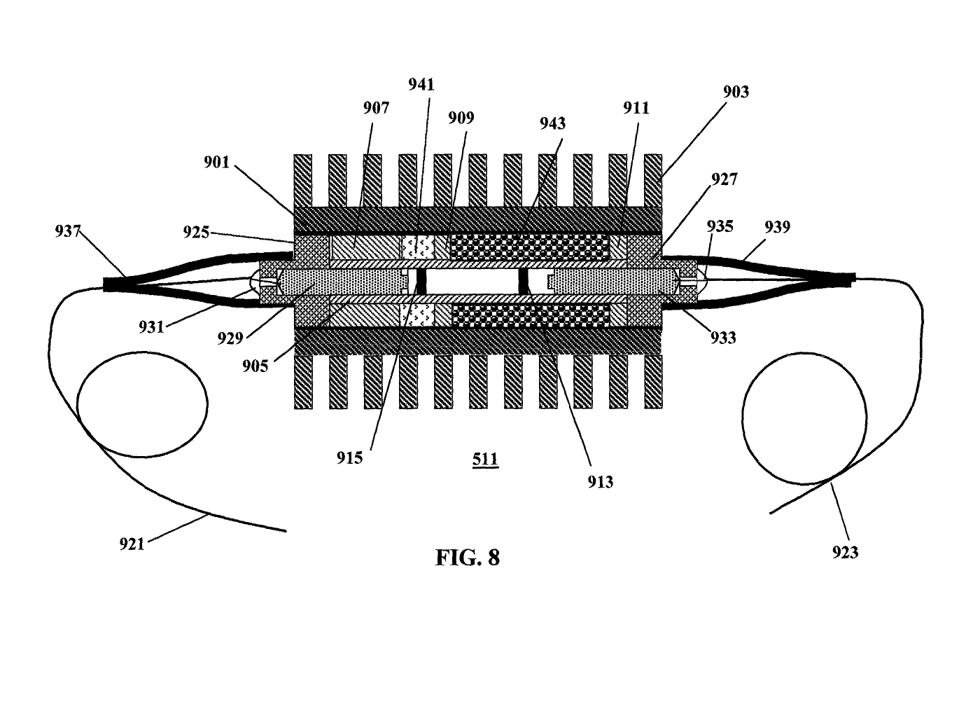

FIG. 8 illustrates a non-reciprocal phase shifter (NRPS) 511 in accordance with the invention. NRPS 511 is a hermetically sealed unit that includes tubular aluminum housing 901 that has a plurality of heat radiating fins 903 disposed on its outer surface. An inner support sleeve or tube 905 is positioned concentric with housing 901. Tube 905 is also of aluminum in the illustrative embodiment. Support washers 907, 909, 911, support tube 905 within housing 901. Disposed within tube 905 are two magneto-optic Faraday rotation devices that are thin film Bismuth Iron Garnet (BIG) crystals 913, 915 Optical signals are coupled to and from the non-reciprocal phase shifter 511 via optical waveguides 921, 923, which in the particular embodiment shown are optical fiber. However, in other embodiments, one or both of the waveguides 921, 923 may be waveguides formed on a substrate and the non-reciprocal phase shifter may be formed on the substrate also as an integrated optic device. Optical fiber 921 extends through a housing cap washer 925 to couple to collimator 929. Epoxy 931 is used to bond fiber 921 in place. Similarly, optical fiber 923 extends through housing cap washer 927 to couple to collimator 933. Epoxy 935 is used to bond fiber 923 in place. Boots 937, 939 are positioned on each housing cap washer 925, 927, respectively to support fibers 921, 923.

A ring shaped permanent magnet 941 is positioned concentric with crystal 913. An electromagnet 943 is disposed proximate crystal 915. A wire coil forms electromagnet 943.

In operation, crystal 915 is fixed at a predetermined rotation angle and crystal 913 is switched from a second predetermined rotation angle to a third predetermined rotation angle to provide for switching of NRPS 511. In the illustrative embodiment of the invention, permanent magnet 941 biases crystal 915 to either +45 degrees or −45 degrees of rotation. The current supplied to electromagnet 943 varies so as to vary the magnetic flux produced and to change its magnetic polarity to vary the Faraday rotation in crystal 113 between +45 degrees and −45 degrees. The combined result is that varying current to electromagnet 943 produces a 0 to 90 degree phase shift by NRPS 511.

The non-reciprocal phase shifter 511 of FIG. 8 is simply assembled, with construction similar to that of optical isolators. Advantageously, non-reciprocal phase shifter 511 provides low insertion loss of 1 dB or less, low cost and small size. More specifically the device of FIG. 1 is 48 mm in length and has an outside diameter of 10 mm without fins 903. With elliptical fins 903, the outside diameter is 28 mm×16 mm.

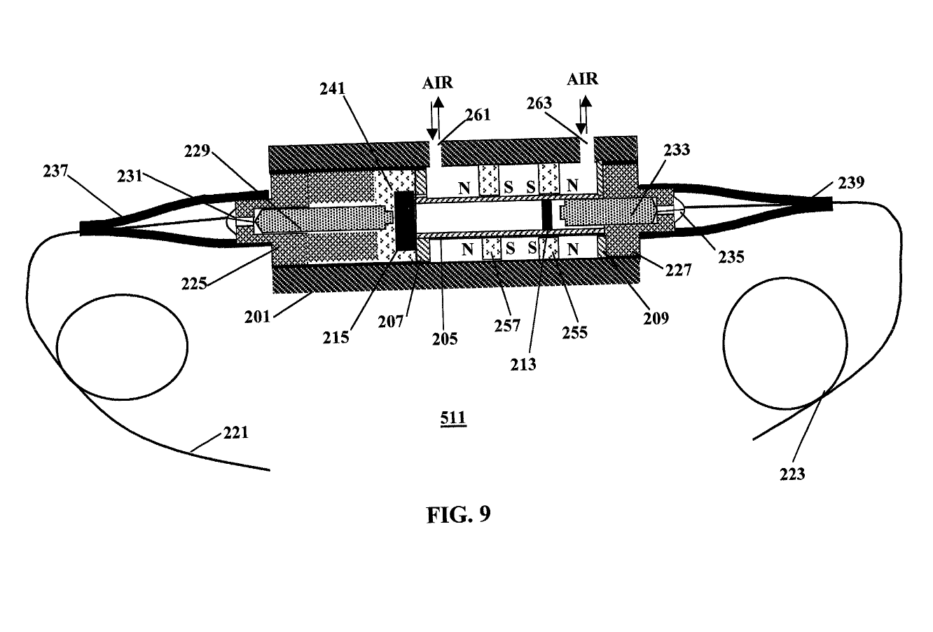

FIG. 9 illustrates a second non-reciprocal phase shifter 511a in accordance with the principles of the invention. Non-reciprocal phase shifter 511a differs in operation from non-reciprocal phase shifter 511 in that it utilizes a pair of permanent magnets in place of the electromagnet of the structure of FIG. 8.

NRPS 511a is a hermetically sealed unit that includes tubular aluminum housing 201. Because no heat generating components are included in NRPS 511a, heat-dissipating fins are not needed. An inner support sleeve or tube 205 is positioned concentric with housing 201. Tube 205 is also of aluminum in the illustrative embodiment. Support washers 107, 109 support tube 105 within housing 101. Disposed within tube 105 are two magneto-optic Faraday rotation devices, i.e., thin film BIG crystals 213, 215. Crystal 215 is supported at one end of tube 205, and crystal 213 is disposed within tube 205. Optical signals are coupled to and from the non-reciprocal phase shifter 200 via optical waveguides 221, 223, which, in the particular embodiment shown, are optical fiber. In other embodiments, one or both of the waveguides 221, 223 may be waveguides formed on a substrate and the non-reciprocal phase shifter may be formed on the substrate also as an integrated optic device. Optical fiber 221 extends through a housing cap washer 225 to couple to collimator 229. Epoxy 231 is used to bond fiber 221 in place. Similarly, optical fiber 223 extends through housing cap washer 227 to couple to collimator 233. Epoxy 235 is used to bond fiber 223 in place. Boots 237, 239 are positioned on each housing cap washer 225, 227, respectively to support fibers 221, 223.

A ring shaped permanent magnet 241 is positioned concentric with crystal 215. A pair of ring shaped magnets 255, 257 is positioned on and longitudinally movable on tube 205. Magnets 255, 257 produce the same magnetic flux density, but are aligned to be of opposite magnetic polarity. Magnets 255,257 are movable from the position shown in FIG. 2 where magnet 255 is concentric with crystal 255 to a second position where Magnet 257 is concentric with crystal 213, and back to the first position. In the first position, magnet 255 causes crystal 213 to produce a first predetermined Faraday rotation in one direction. In the second position, magnet 257 causes crystal 213 to produce a second predetermined Faraday rotation in the opposite direction Movement of the pair of magnets 255, 257 to positions intermediate the first and second positions produces Faraday rotations in between the first and second predetermined Faraday rotations. The advantage to this arrangement is that magnets 255, 257 may be moved by mechanical means such as pressurized air or vacuum in ports 261, 263 that are provided in housing 201. The magnet positions are stable in all positions and accordingly, the magnets will; latch in any of the positions intermediate the first and second positions. Advantageously, no continuous energy must be expended to maintain the magnets 255,257 in any position.

In operation, crystal 215 is fixed at a predetermined Faraday rotation angle. Crystal 213 is varied from a second predetermined Faraday rotation angle to a third predetermined Faraday rotation angle to provide for varying the non-reciprocal phase shift of NRPS 511a. In the illustrative embodiment of the invention, permanent magnet 241 biases crystal 915 to either +45 degrees or −45 degrees of rotation Magnets 955, 257 are movable to vary the magnetic field at crystal 913 between two predetermined rotation angles of +45 degrees and 45 degrees. The combined result is that movement of magnets 255, 257 produces a cumulative phase shift in non-reciprocal phase shifter 511a that may be varied from 0 degrees to 90 degrees. Non-reciprocal phase shifter 511a is latchable.

Non-reciprocal phase shifter 511a of FIG. 9 is also simply assembled, with construction similar to that of optical isolators. Advantageously, non-reciprocal phase shifter 200 provides low insertion loss of 1 dB or less, low cost and small size.

As will be appreciated by those skilled in the art, various modifications can be made to the embodiments shown in the various drawing figures and described above without departing from the spirit or scope of the invention In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. An optical fiber network comprising:
a plurality of communications nodes, each of said nodes being able to communicate utilizing multiplexed optical signals comprising a plurality of optical wavelength components;
a plurality of optical fiber links interconnecting said nodes;
a plurality of dynamic balancers, each said dynamic balancer being inserted into a corresponding one of said optical fiber links, each said dynamic balancer adjusting intensities of a plurality of optical wavelength components in multiplexed optical signals transmitted over said one optical fiber link.

2. An optical fiber network in accordance with claim 1, wherein:
each said dynamic balancer adjusts said intensities to be substantially the same level.

3. An optical fiber network in accordance with claim 1, wherein:
each said dynamic balancer comprises a control loop for each optical wavelength component, said control loop being used to adjust said intensities.

4. An optical fiber network in accordance with claim 3, wherein:
each said dynamic balancer comprises a single micro controller utilized for all of said control loops.

5. An optical fiber network in accordance with claim 1, wherein:
each said dynamic balancer comprises a plurality of variable optical attenuators, each operable to provide adjust the intensity of one corresponding optical wavelength component of said plurality of optical wavelength components, and a micro-controller coupled to each of said variable optical attenuators to provide a plurality of control loops for adjusting the intensities of all of said optical wavelength components of said plurality of optical wavelength components.

6. An optical fiber network in accordance with claim 5, wherein:
each of said variable optical attenuators comprises a reflective attenuator.

7. An optical fiber network in accordance with claim 5, wherein:
said micro-controller adjusts said intensities of all of said optical wavelength components to predetermined levels.

8. An optical fiber network in accordance with claim 5, wherein:
said micro-controller adjusts said intensities of all of said optical wavelength components to the same predetermined level.

9. An optical fiber network in accordance with claim 5, wherein:
each said variable optical attenuators comprises an adjustable non-reciprocal phase shifter.

10. An optical fiber network in accordance with claim 9, wherein:
each said variable optical attenuators comprises a coupler, and an optical fiber loop, said adjustable non-reciprocal phase shifter being coupled into said optical fiber loop.

11. An optical fiber network in accordance with claim 1, wherein;
each said dynamic balancer comprises a de-multiplexer receiving and demultiplexing wavelength multiplexed signals into said plurality of optical wavelength components.

12. An optical fiber network in accordance with claim 11, wherein:
each said dynamic balancer comprises a multiplexer coupled to each of said variable optical attenuators to multiplex adjusted intensity optical wavelength components into output multiplexed optical wavelength signals.

13. An optical fiber network in accordance with claim 12, wherein:
said multiplexer and said de-multiplexer of each dynamic balancer are a combined unit.

14. An optical fiber network in accordance with claim 1, wherein:
each said dynamic balancer comprises a multiplexer coupled to each of said variable optical attenuators to multiplex adjusted intensity optical wavelength components into output multiplexed optical wavelength signals.
